(19) United States
(12) Patent Application Publication
(10) Pub. No.: US 2006/0283029 A1
(43) Pub. Date: Dec. 21, 2006

(54) Multi-beam laser level

(76) Inventors: Der-Shyang Jan, Taipei (TW); Jay Chang, Sijhih City (TW)

Correspondence Address: Raymond Sun, 12420 Woodhall Way, Tustin, CA, 92782, US

(21) Appl. No.: 11/287,693

(22) Filed: Nov. 28, 2005

(30) Foreign Application Priority Data
Jun. 21, 2005 (TW) 942104210

(51) Int. Cl. G01C 15/00

(52) U.S. Cl. 33/286

(57) ABSTRACT

A laser level generates a first, a second and a third laser beam which are perpendicular to each other. The laser level includes a first laser generator for generating the first laser beam, a second laser generator for generating an incident laser beam, and a prism disposed in front of the second laser generator for splitting the incident laser beam into the second and the third laser beams. A plurality of vials are provided for indicating the level of the respective first, second and third laser beams, and a housing accommodates the first laser generator, the second laser generator, the prism and the vials.

### BACKGROUND OF THE INVENTION

1. Field of the Invention

The present invention relates to a laser level, and in particular, to a laser level capable of generating three beams which are perpendicular to each other.

2. Description of the Prior Art

It is a common practice in architecture and decoration to use a level as an auxiliary instrument for measuring the level and verticality of a work target. Recently, due to advances in laser technology, laser levels capable of generating laser beams for measuring the level and verticality of a work target have been widely used.

There are a number of laser levels with different functions in the market to meet a variety of user requirements. However, there is still a need for a multi-beam laser level that has low cost and high precision, so as to provide users with diversified options.

### SUMMARY OF THE INVENTION

It is an object of the present invention to provide a laser level capable of generating three laser beams which are perpendicular with each other.

It is another object of the present invention to provide a laser level which has high precision with low cost.

In order to achieve the objectives of the present invention, there is provided a laser level capable of generating a first, a second and a third laser beam which are perpendicular to each other. The laser level includes a first laser generator for generating the first laser beam, a second laser generator for generating an incident laser beam, and a prism disposed in front of the second laser generator for splitting the incident laser beam into the second and the third laser beams. A plurality of vials are provided for indicating the level of the respective first, second and third laser beams, and a housing accommodates the first laser generator, the second laser generator, the prism and the vials.

### BRIEF DESCRIPTION OF THE DRAWINGS

FIG. 1 is a perspective view of a multi-beam laser level in accordance with one embodiment of the present invention.

FIG. 2 is an exploded perspective view of the laser level of FIG. 1.

FIG. 3A is a rear elevational view of the base in FIG. 2.

FIG. 3B is a cutaway view of the base along line A--A in FIG. 3A.

FIGS. 4 and 5 illustrate different ways in which the laser level of FIG. 1 can be used.

### DETAILED DESCRIPTION OF THE PREFERRED EMBODIMENTS

The following detailed description is of the best presently contemplated modes of carrying out the invention. This description is not to be taken in a limiting sense, but is made merely for the purpose of illustrating general principles of embodiments of the invention. The scope of the invention is best defined by the appended claims.

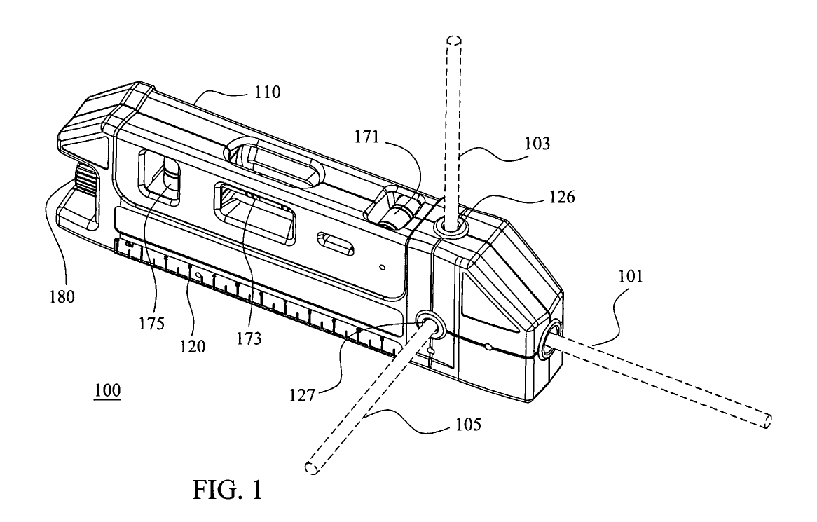

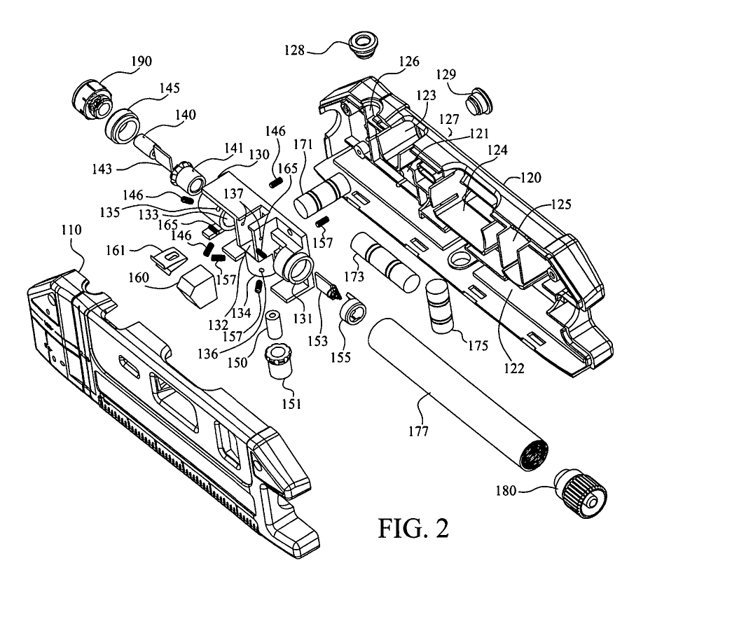

FIGS. 1-3 illustrate a laser level in accordance with one embodiment of the present invention. The laser level 100 is capable of generating three laser beams 101, 103 and 105 which are perpendicular to each other. Moreover, the laser level 100 in FIG. 2 further includes a cross lens 190 that functions to convert the first laser beam 101 into a cross laser beam (not shown). Therefore, a user can use the laser level 100 to measure the level and verticality of work targets, as well as the included angle therebetween.

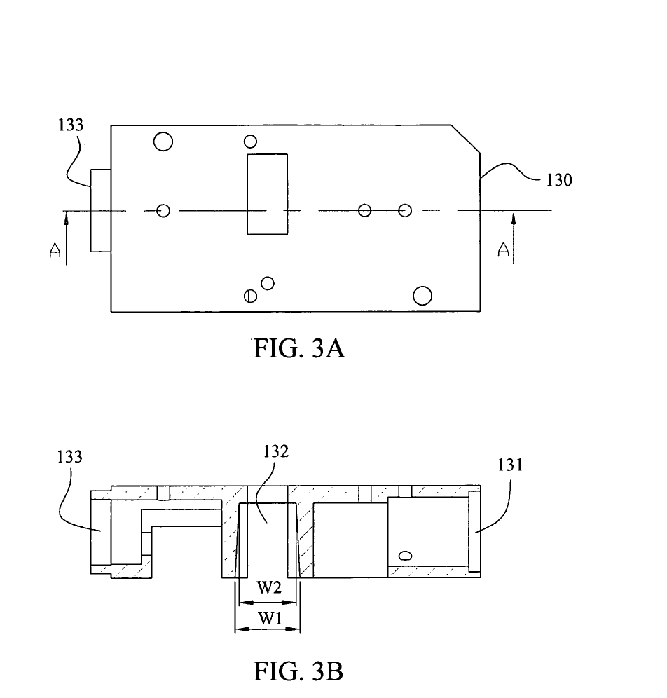

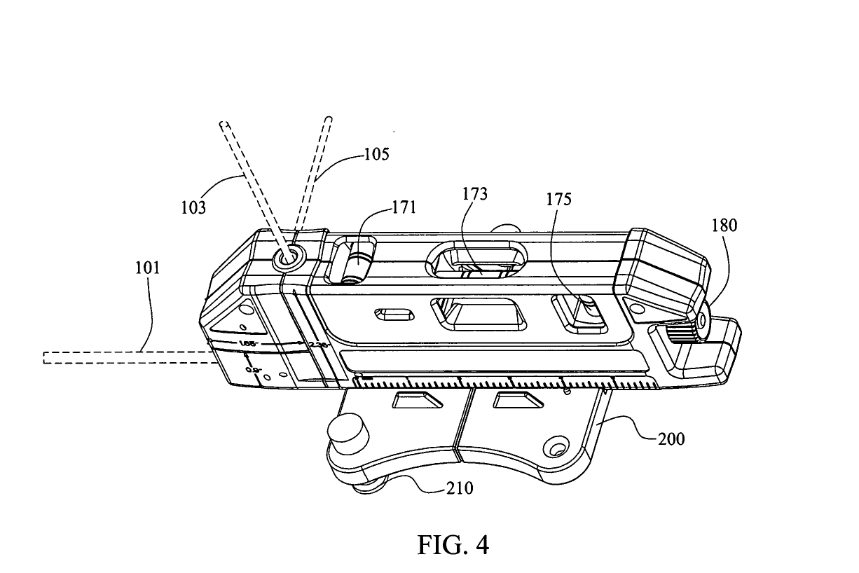

Referring now to FIG. 2, the laser level 100 includes a left cover 110, a right cover 120, a base 130, laser generators 140 and 150, a pentagonal prism 160, vials 171, 173 and 175, a battery tube 177, a button switch 180 and a cross lens 190. The base 130 has a connector 131, a prism trench 132 and bores 133 and 134, with the bores 133 and 134 being perpendicular to each other. The bore 133 is provided with three screw holes 135 evenly spaced apart around its periphery, and the bore 134 is also provided three screw holes 136 evenly spaced apart around its periphery. As shown in FIGS. 2 and 3B, the top width W1 of the prism trench 132 is designed to be wider than the bottom width W2 of the prism trench 132, and each sidewall of the prism trench 132 is provided with a screw hole 137.

The laser generator 140 is received inside an adjustment seat 141 which is then inserted in the bore 133, and then three screws 146 are screwed through the three screw holes 135 around the periphery of the bore 133 to adjust the inclination of the laser generator 140. Similarly, the laser generator 150 is received inside an adjustment seat 151 and inserted in the bore 134, and then three screws 157 are screwed through the three screw holes 136 around the periphery of the bore 134 to adjust the inclination of the laser generator 150.

As shown in FIG. 2, the circuit board 143 and the laser generator 140 are connected together, whereas the circuit board 153 and the laser generator 150 are disposed separately. The circuit board 153 is disposed in a fixed seat 155 and then secured at the front end of the battery tube 177. The circuit board 153 is electrically connected to the laser generator 150 and the circuit board 143 by wires (not shown). The button switch 180 is connected to the rear end of the battery tube 177 to switch on and off the power of the laser generators 140 and 150, and in turn to control the generation of the laser beams 101, 103 and 105.

The pentagonal prism 160 is secured in the prism trench 132 by a clip 161 and two screws 165. The two screws 165 are screwed through the respective screw holes 137 on both sidewalls of the prism trench 132 to adjust the inclination of the pentagonal prism 160 inside the prism trench 132. The battery tube 177 is connected to the connector 131 of the base 130 and is adapted to accommodate batteries (not shown) for supplying power to the laser generators 140 and 150. The base 130, the battery tube 177 and the vials 171, 173 and 175 are accommodated in the corresponding recesses 121, 122, 123, 124 and 125 that are defined by the left cover 110 and the right cover 120. The light exit windows 126 and 127 (shown in FIGS. 1 and 2) of the laser level 100 can be covered by dust caps 128 and 129 respectively.

As shown in FIG. 2, an adapter ring 145 is connected to the front end of the bore 133, such that the cross lens 190 can be selectively connected to the adapter ring 145. The cross lens 190 is adapted to convert the laser beam 101 generated by the laser generator 140 into a laser beam that can project a cross laser line onto a target to provide additional measurement functions.

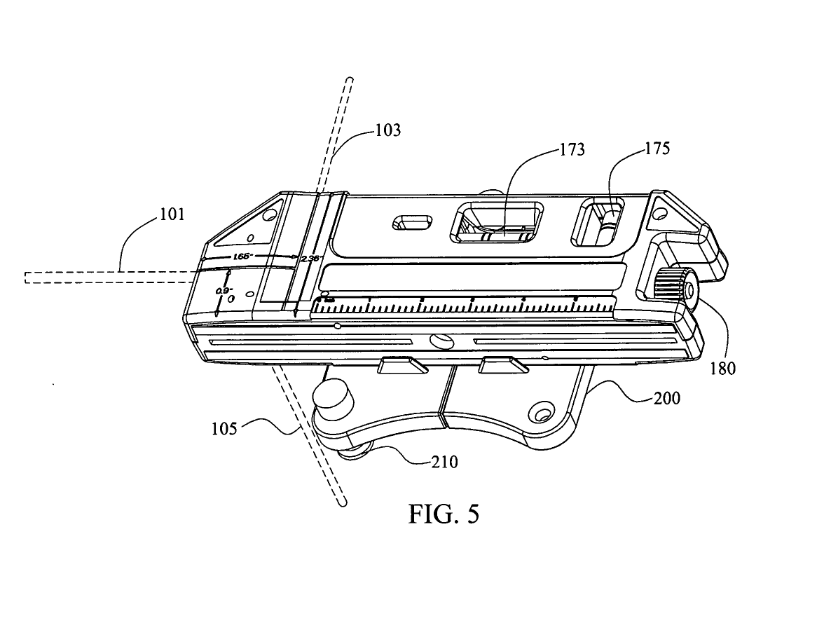

FIGS. 4 and 5 illustrate two different applications for the laser level 100. In FIG. 4, the laser level 100 is oriented vertically on an adjustment base 200. The inclination of the laser level 100 can be adjusted by adjusting the height of the legs 210 of the adjustment base 200 while referring to the levels on the vials 171 and 173. This adjustment will properly align the horizontal laser beams 101 and 105 and the upward vertical laser beam 103 with respect to the ground when the laser level 100 is placed on an uneven surface. Therefore, the level, verticality and included angle of work targets can be accurately measured.

In FIG. 5, the laser level 100 is oriented laterally on the adjustment base 200 so that the inclination of the laser level 100 can be adjusted by adjusting the height of the legs 210 of the adjustment base 200 while referring to the vials 173 and 175, when the laser level 100 is placed on an uneven surface. In this application, the horizontal laser beams 101 and 103 and the downward vertical laser beam 105 with respect to the ground are provided to measure the level, verticality and included angle of work targets.

In accordance with one embodiment of the present invention, the left cover 110 and right cover 120 of the laser level 100 can be made of plastic, and the base 130 of the laser level 100 can be made of zinc alloy, to reduce cost and maximize the precision of the laser level 100. In this regard, providing all of the covers 110, 120 and the base 130 in plastic would achieve the lowest cost, but the precision of the laser level 100 might be compromised. Providing the base 130 in a zinc alloy will provide sufficient hardness for the base 130 to facilitate accurate adjustments, thereby striking an effective balance between cost and precision.

Those skilled in the art will appreciate that the right cover 120 (or the left cover 110) and base 130 can be made in one piece if the right cover 120 (or the left cover 110) and base 130 are made of the same material (such as metal).

While the description above refers to particular embodiments of the present invention, it will be understood that many modifications may be made without departing from the spirit thereof. The accompanying claims are intended to cover such modifications as would fall within the true scope and spirit of the present invention.

What is claimed is:

1. A laser level capable of generating a first laser beam, a second laser beam and a third laser beam which are perpendicular to each other, comprising:
a first laser generator for generating the first laser beam;
a second laser generator for generating an incident laser beam;
a prism disposed in front of the second laser generator for splitting the incident laser beam into the second and the third laser beams;
a plurality of vials for indicating the level of the respective first, second and third laser beams; and
a housing for accommodating the first laser generator, the second laser generator, the prism and the vials.

2. The laser level of claim 1, wherein the housing comprises:
a base having a connector, a prism trench for accommodating the prism, a first bore for accommodating the first laser generator and a second bore for accommodating the second laser generator, with the first and second bores being perpendicular to each other;
a battery tube connected to the connector;
a right cover having corresponding recesses to accommodate the base, the battery tube and the vials; and
a left cover for covering the right cover.

3. The laser level of claim 2, wherein each of the first and the second bores has a plurality of screw holes that are spaced apart around the periphery of the bore, with a plurality of screws screwed into respective screw holes to adjust the inclination of the first and the second laser generators.

4. The laser level of claim 2, wherein the prism trench has a plurality of side walls, and a width between the sidewalls, wherein the width at the top is wider than the width at the bottom, and each of the sidewalls of the prism trench has a screw hole with a screw screwed therein to adjust the inclination of the prism.

5. The laser level of claim 2, wherein the base is made of zinc alloy.

6. The laser level of claim 2, wherein the right and left covers are made of plastic.

7. The laser level of claim 2, wherein the prism is secured in the prism trench by a clip.

8. The laser level of claim 1, further comprising a button switch for controlling the power of the first and second laser generator.

9. The laser level of claim 1, further comprising a cross lens disposed in front of the first laser generator to convert the first laser beam into a cross laser beam.

10. The laser level of claim 1, wherein the prism is a pentagonal prism.

11. A laser level capable of generating a first laser beam, a second laser beam and a third laser beam which are perpendicular to each other, comprising:
a first laser generator for generating the first laser beam;
a second laser generator for generating an incident laser beam;
a prism disposed in front of the second laser generator for splitting the incident laser beam into the second and the third laser beams;
a plurality of vials for indicating the level of the respective first, second and third laser beams; and
a housing for accommodating the first laser generator, the second laser generator, the prism and the vials, the housing including a base having a prism trench for accommodating the prism, the prism trench having a plurality of side walls, and a width between the sidewalls, wherein the width at the top is wider than the width at the bottom, and wherein each of the sidewalls of the prism trench has a screw hole with a screw screwed therein to adjust the inclination of the prism.
